(19) United States
(12) Patent Application Publication
(10) Pub. No.: US 2009/0248807 A1
(43) Pub. Date: Oct. 1, 2009

(54) System and Method of Matching Presence for Subscribers in a Social Network

(75) Inventors: Christopher A. Fron, Raleigh, NC (US); Tia S. Fron, Raleigh, NC (US); Robert R. Wilson, Raleigh, NC (US)

Correspondence Address: COATS & BENNETT, PLLC, 1400 Crescent Green, Suite 300, Cary, NC, 27518, US

(73) Assignee: Ami-Go Group, Inc., Raleigh, NC (US)

(21) Appl. No.: 12/055,738

(22) Filed: Mar. 26, 2008

(51) Int. Cl. G06F 15/16

(52) U.S. Cl. 709/206

(57) ABSTRACT

A social network allows subscribers to build and maintain a network of friends. The network includes a server that maintains travel information for the subscribers and for their friends. The server analyzes this travel information to determine whether a given subscriber will be geographically near a friend for a predetermined amount of time. If so, the server notifies the subscriber, and possibly the friend as well, so that the two can arrange to meet during that time.

### FIELD OF THE INVENTION

The present invention relates generally to social networking, and particularly systems and methods for notifying subscribers in a social network when they will be geographically near their friends.

### BACKGROUND

Social networks are web-based services for people who share similar interests and activities, or who are interested in meeting others. With these services, a subscriber creates a personal profile to describe themselves and their interests. In most cases, subscribers may also upload video, images, and music files to share with others. Most social network services also permit the subscriber to create a “network” or community of friends, family, and acquaintances. These networks can contain people from all over the world. Once the subscriber creates the network, he or she can interact with those in his or her network through the service.

Some of the more popular social network services include LINKEDIN, MYSPACE and FACEBOOK. Subscribers can spend hours on their site manually entering information to update their profiles and communicate with their network of friends and family. However, for all their functions, social networks do not automatically determine if subscribers within a network will be geographically proximate to each other for a definite period of time. This can be distressing because a subscriber's network can contain people that the subscriber does not have the opportunity to meet very often.

### SUMMARY

In one embodiment, a social network comprises a network server that allows subscribers to build and maintain a social network of people that the subscriber interacts with. These people that are in the subscriber's social network are referred to herein as “friends.” The server comprises a service logic module that receives and maintains travel information for the subscriber and the subscriber's friends. The service logic module analyzes the travel information to determine whether a subscriber will be geographically near one or more of the subscriber's friends. More particularly, the service logic module determines whether a subscriber and a friend will be within a predefined distance of one another during their travels, and further, if they will remain near each other for at least a predefined period of time. If so, the service logic module will notify the subscriber and/or the friend so that, upon receiving the notification(s), the subscriber and/or the friend can contact one another to arrange a meeting.

The service logic module may receive the travel information in any of a variety of ways. In one embodiment, a client device associated with the subscriber displays a webpage provided by a network server. The webpage content includes HyperText Markup Language (HTML) code used to display a travel itinerary. The subscriber's device “scrapes” the HTML content from the display by copying the HTML code used to display the travel itinerary, and sends the scraped content to the service logic module in a message. Upon receipt, the service logic module parses the content to obtain the travel information. The service logic module then saves the travel information, and uses it to determine whether the subscriber and a friend will be geographically near one another for a predetermined amount of time.

### BRIEF DESCRIPTION OF THE DRAWINGS

FIG. 1 is a block diagram illustrating some of the components of a communication system suitable for use in one embodiment of the present invention.

FIG. 2 is a block diagram that illustrates some of the functional components of an application configured according to one embodiment of the present invention.

FIG. 3 is a flow diagram illustrating how the present invention might operate to notify subscribers according to one embodiment of the present invention.

FIG. 4 is a flow diagram illustrating how subscribers might build a social network of friends according to one embodiment of the present invention.

FIG. 5 is a flow chart illustrating how the present invention could receive a subscriber's travel information according to one embodiment.

FIG. 6 illustrates an exemplary display screen having information that the present invention could parse according to one embodiment.

FIG. 7 is a flow diagram illustrating how the travel information displayed in FIG. 6 might be sent to the service logic according to one embodiment of the present invention.

FIG. 8 is a flow diagram illustrating a method of parsing the received travel information according to one embodiment of the present invention.

FIGS. 9A-9C are flow diagrams illustrating a method of parsing the received travel information according to one embodiment of the present invention.

FIG. 10 is a flow diagram illustrating some events that could trigger the present invention to analyze travel information according to one embodiment.

FIG. 11 is a flow diagram illustrating a method by which one embodiment of the present invention determines whether a subscriber and a friend will be geographically proximate each other for some predetermined period of time.

FIG. 12 is a flow diagram illustrating how the present invention adds a new trip input by a subscriber according to one embodiment.

FIG. 13 is a flow diagram illustrating how the present invention cancels an existing trip for a subscriber according to one embodiment.

FIG. 14 is a flow diagram illustrating how the present invention adds new friends for a subscriber according to one embodiment.

FIG. 15 is a flow diagram illustrating how the present invention changes existing trips for a subscriber according to one embodiment.

FIG. 16 is a flow diagram illustrating how the present invention receives travel itineraries according to one embodiment of the present invention.

### DETAILED DESCRIPTION

The present invention is directed to a system and method that informs subscribers in a social network that they will be geographically near one another for some predetermined period of time. In one embodiment, each subscriber identifies one or more other subscribers as friends. In addition to using the system to share data and information with those friends, the system permits the subscribers to input their travel information. The system periodically analyzes the travel information of a subscriber and the subscriber's friends to determine their relative locations during travel. If the subscriber will be located near a friend for a predetermined period of time, the system will notify the subscriber and/or the friend that they will cross paths. The subscriber and/or the friend can then contact the other and set up a meeting as desired. This permits a subscriber to maintain contact with people that the subscriber does not have the opportunity to meet with often.

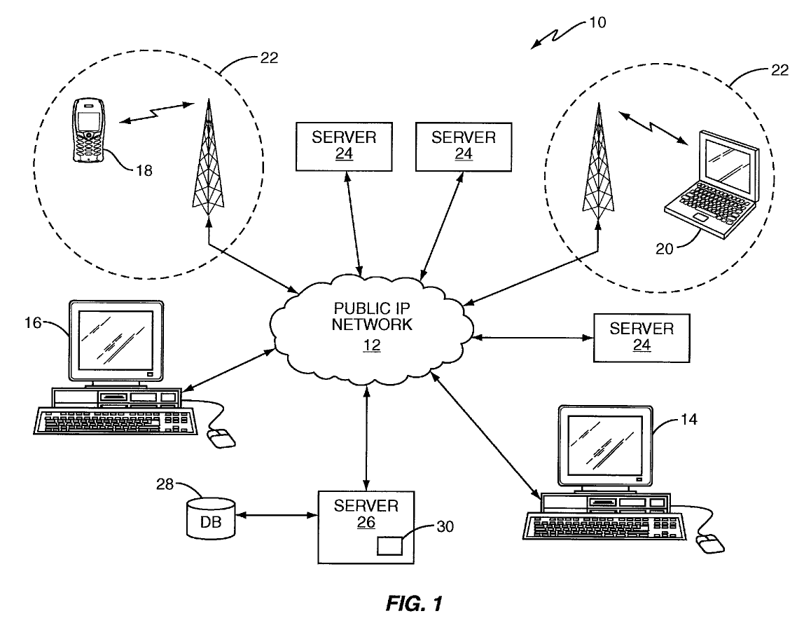

Turning now to the drawings, FIG. 1 illustrates a functional block diagram of a representative communication system 10 suitable for use in one embodiment of the present invention. As seen in FIG. 1, system 10 comprises a public IP communication network 12, such as the Internet. The IP network 12 generally comprises one or more publicly accessible, interconnected computer networks that enables users to transmit and receive data. According to the present invention, these end users are subscribers to a social network that keeps them informed as to when they will cross paths with other subscribers.

Some subscribers have desktop computers 14, 16 that connect to the IP network 12 using an Ethernet-based interface adapter cards such as 10-BASE-T, Fast Ethernet, or 10 GbE, for example, or a wireless interface card operating according to WiFi standards (e.g., IEEE 802.11) or BLUETOOTH. Other subscribers may have portable communication devices, such as a mobile device 18 or laptop computer 20, that connect to the IP network 12 via any of a variety of wireless communication networks 22. Exemplary networks 22 include Time Division Multiple Access (TDMA) networks such as a Global System for Mobile Communications (GSM) network and a General Packet Radio Service (GPRS), Code Division Multiple Access (CDMA) networks such as a Wideband Code Division Multiple Access (WCDMA) network, and Orthogonal Division Frequency Multiplexing (OFDM) network, such as a WiMAX network.

Those skilled in the art will appreciate that the aforementioned access technologies are not the only technologies available to connect the subscriber devices 14, 16, 18, 20 to the IP network 12 to allow them to communicate data packets. There are many other interfaces and networks not specifically shown here that may be used to connect the subscriber devices 14, 16, 18, and 20 to the IP network 12, and thus, are just as suitable for use with the present invention.

FIG. 1 also illustrates a crossing paths server 26 that helps registered users arrange meetings with friends. The crossing paths server includes a database 28 to store information about the home location and travel plans of registered users, and a crossing paths application 30 that that matches the known locations of registered users and provides notification when two or more registered users will be in the same general location at the same time (i.e., when the registered user's cross paths). More particularly, the registered users store information about their respective home locations and travel plans in the database 28. The crossing paths application 30 may provide a web interface that allows users to enter and edit their profiles and travel information. Users can define a social network comprising one or more friends with whom the user would like to stay in touch. The crossing paths application 30 compares the home locations and travel plans of registered users in a defined social network and notifies registered users when the known locations of friends match.

In some embodiments, the registered users may use on-line travel and booking services, such as Expedia and Travelocity, to make airline and hotel reservations. FIG. 1 illustrates a number of web servers 24 associated with on-line travel services and connected to the IP network 12. Generally, the on-line travel agencies maintain a web site that allows subscribers to make reservations on-line. Once the agencies book the subscriber's travel arrangements, they retain the information in a database (not shown) and provide confirmations to the users. Confirmations may be printed by the user at the time the reservations are made, or may be sent by email from the travel services to the users. The users can then enter the information into a calendar to reflect the travel arrangements. In some embodiments of the invention, the on-line travel services or users may send the travel confirmation to the crossing paths server 26 via e-mail so that the travel information does not need to be manually entered by the user.

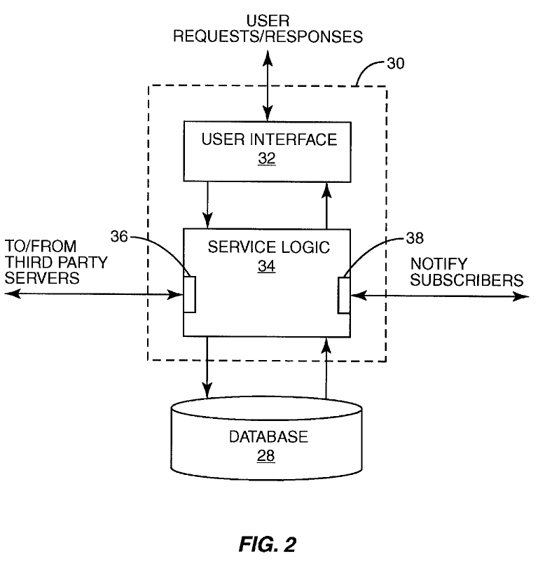

FIG. 2 illustrates the main functional components of the crossing paths application 30. According to one embodiment of the present invention, crossing paths application 30 includes a user interface module 32 and a service logic module 34. Generally, the user interface module 32 provides the subscribers with a web interface that allows the users to enter and edit user profiles as well as travel information. Subscribers may use the web interface to register with the crossing paths service and build a social network of friends. The user profiles contain subscriber information, such as account and billing information, home address, contact information, etc. The user preferences also includes user preferences information that defines their personal preferences for the service. As described later in more detail, the preferences may define a maximum distance that a subscriber is willing to travel to meet a friend, and/or a minimum amount of time that the subscriber must be near the other friend. Other preferences are also possible. Once a user account is created, the user can create a social network and enter travel information, and the crossing paths server will notify the user when the user will be in the vicinity of a friend in his/her social network.

The service logic 34 comprises one or more modules that implement the functionality for the crossing paths service. The service logic comprises a database module for maintaining a database of user information, an analysis module for analyzing user travel information, and communications module for providing notifications to users when a user will be in the vicinity of a friend in his/her social network. In one exemplary embodiment, the analysis module may include a parsing function that can extract user travel information from electronic confirmations received from on-line travel services. The service logic 34 then parses the electronic confirmations received from on-line travel services to determine subscribers' travel arrangements, stores the extracted information in the database 28, and performs a matching function based on the subscriber(s) profiles to determine whether those travel arrangements will bring two or more subscribers that are friends in the same social network within close physical proximity to each other for a predetermined time. If the service logic 34 determines that subscribers within the same social network will be near the same physical geographical location at substantially the same time for some predetermined length of time, the service logic 34 will generate and send a notification to one or both of the identified subscribers via a second communication interface 38 and IP network 12.

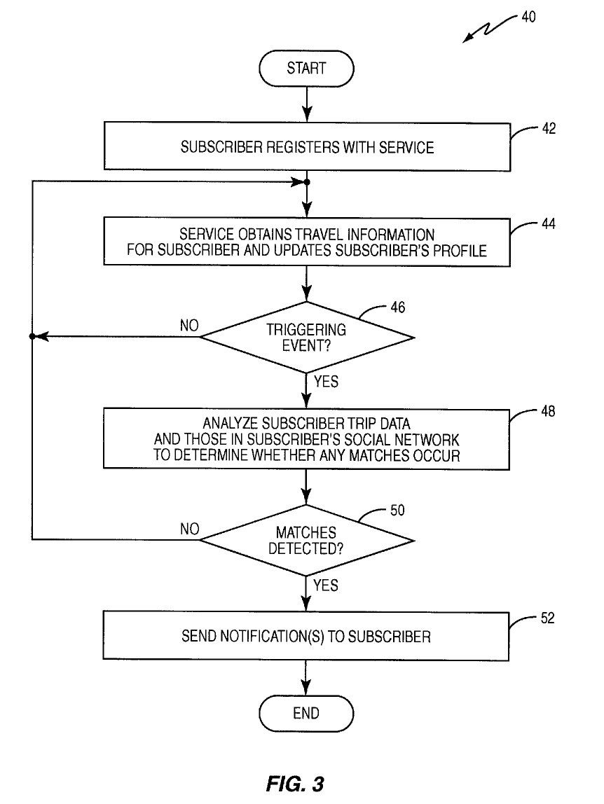

FIG. 3 is a flow chart illustrating a method 40 by which crossing paths application 30 determines when two or more subscribers within the same social network will cross paths. Method 40 begins when a subscriber registers with the service (box 42). For example, a subscriber may register with the service via the IP network 12 using any of the subscriber communication devices 14, 16, 18, 20 seen in FIG. 1. The subscriber may identify and invite other people to be in the subscriber's social network. Those invitees that accept the invitation are collectively referred to herein as “friends.” During registration, the subscriber may define any personal preferences that could affect notifications about meeting with friends while traveling.

Once the subscriber is registered with the service, the service logic 34 will periodically or sporadically obtain travel information for the user (box 44). As stated previously, user travel information may be provided in email confirmations by on-line travel services. Additionally, however, the subscriber may enter travel information manually through a web interface or, as described in more detail later, generate the information at a subscriber device 14, 16, 18, 20 and forward it to service logic 34.

The service logic 34 determines whether the subscriber and any of the subscriber's friends will be geographically near each other upon receiving a triggering event (box 46). A triggering event may be, for example, the receipt or update of the subscriber's travel plans by service logic 34. Another triggering event might be the receipt or update of a friend's travel plans by service logic 34. Whenever a triggering event occurs, the service logic 34 will analyze the subscriber's profile as well as those of the subscriber's friends (box 48). Particularly, the service logic 34 will execute a matching function to determine whether the subscriber will be geographically near at least one friend at substantially the same time. If the service logic 34 detects such a match (box 50), the service logic 34 will generate a notification message, such as an email notification or SMS notification, and send it to the subscriber and/or to the subscriber's friend (box 52).

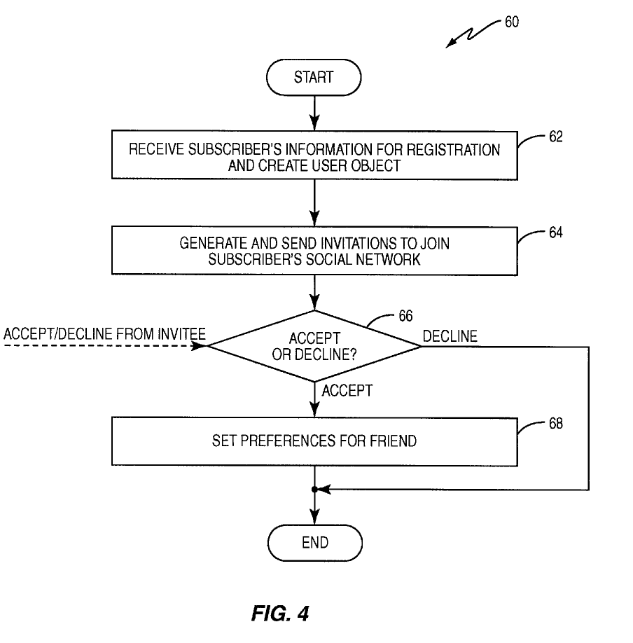

FIG. 4 is a flow chart of a method 60 that illustrates an exemplary method for registering a subscriber and creating a social network of friends for the subscriber. Method 60 begins when the service logic 34 receives a user subscription and creates a software construct called a “subscriber object” for the new subscriber (box 62). The subscriber object will store the subscriber and preference information received during the registration process from the subscriber. To register for the service, the subscriber will typically navigate to a web page for the service. The user interface 32 will provide the subscriber's device (e.g., device 14, 16, 18, 20) with a display screen that includes a subscription form for the subscriber to fill in. The following table details some of the information that the subscriber object may contain, some of which the service may request from the subscriber.

TABLE 1
Registration Information

| Field | Description |
|---|---|
| User ID | A unique identifier selected by the user to identify |
| | themselves to others (e.g., a user name or a screen name) |
| Internal | A unique identifier assigned to the user by the service. The |
| ID | internal ID is not requested from, or displayed to, the user. |
| First | The first name of the user. |
| Name | |
| Last Name | The last name of the user |
| Email | A user-designated email address. The user will receive all |
| Address | service-related communications at this email address. |
| | These include, but are not limited to, notifications regarding |
| | invitations and possible meetings. |
| City | The city that the user lives in. |
| State | The state that the user lives in. |
| Country | The country that the user lives in. |
| Zip Code | The user's zip code. |
| Location | A list of identifiers that identify one or more origination |
| Origin | locations from which the user typically starts trips. |
| Friends | A list of Internal IDs that uniquely identify the user's friends. |
| | These are contained in the subscriber object, but not |
| | obtained via the subscription form. |

The Location Origin may be, for example, a list of airport codes that identify one or more airports where the subscriber typically starts his trips. Additionally, however, the Location Origin may be codes that indicate bus terminals or train stations. The Internal IDs uniquely identify each subscriber object, and thus, uniquely identify a registered subscriber. In the above example, the “Friends” field is a list of people (i.e., a list of Internal IDs corresponding to those people) that the subscriber has as friends. Based on subscriber preferences, the service logic 34 will notify these friends whenever the subscriber's travel plans bring them geographically proximate to each other for some predetermined length of time. Similarly, the subscriber's own internal ID may be stored in other people's subscriber objects to identify the subscriber as that person's friend. Thus, service logic 34 may notify the subscriber whenever a friend's travel plans bring them near to each other for some predetermined length of time.

Once registered, the subscriber then begins to build his social network. Building the social network may be accomplished using any means known in the art. In this embodiment, however, the subscriber identifies one or more people as friends. The service logic 34 generates an invitation message for each identified person, and sends the message to the email address of each person (box 64). The invitation may include one or more links (e.g., Universal Resource Locators (URL)) that a receiving person can activate to accept or decline the offer. If the person declines the subscriber's offer (box 66) the method ends. Otherwise, when the person accepts, the service logic 34 obtains the following subscriber preference information for each “friend.”

TABLE 2
Friend Data

| Field | Description |
|---|---|
| Friend's | The unique identifier assigned to the friend by the service. |
| Internal | It is used, for example, to link the friend's user object. Not |
| ID | displayed to the user. |
| Minimum | This field is provided by the user. It identifies the |
| Time | minimum length of time (e.g., in minutes) that the user |
| Overlap | and the friend must be in nearly the same location at |
| | nearly the same time to qualify for user notification. |
| Reasonable | This field is provided by the user. It identifies the |
| Distance | maximum distance (e.g., in miles) that the user is willing |
| | to travel to meet this friend. |

Except for the friend's Internal ID, the subscriber provides the preference information. Further, the preference information may be different for each friend. For example, specifying a relatively small value for the Minimum Time Overlap field would indicate that the subscriber would be willing to meet that friend even if they were near each other only for a short time. The subscriber could enter larger values, however, for other friends. Similarly, the subscriber may enter different values in the Reasonable Distance field for different friends to indicate the distance that the subscriber would be willing to travel to meet that friend.

For example, consider a subscriber that enters values of “120” and “20” in the Minimum Time Overlap field and Reasonable Distance Field, respectively, for a given friend. Those values would indicate that the subscriber is willing to travel up to 20 miles to meet that friend if they are near each other for at least 120 minutes. However, that friend may have different values for the subscriber indicating that the friend would be willing to travel a farther/shorter distance if they remained near the subscriber for a longer/shorter time. The service logic 34 employs geographical data stored in DB 28 to determine a distance between a subscriber and a friend.

Once the subscriber has registered with the service and has set his preferences, the service logic 34 may receive and maintain information about the subscriber's trips. The information associated with these trips will be used by the service logic 34 to determine whether a subscriber will be near a given friend or whether the friend will be near the subscriber, and whether the subscriber (and/or the friend) should be notified.

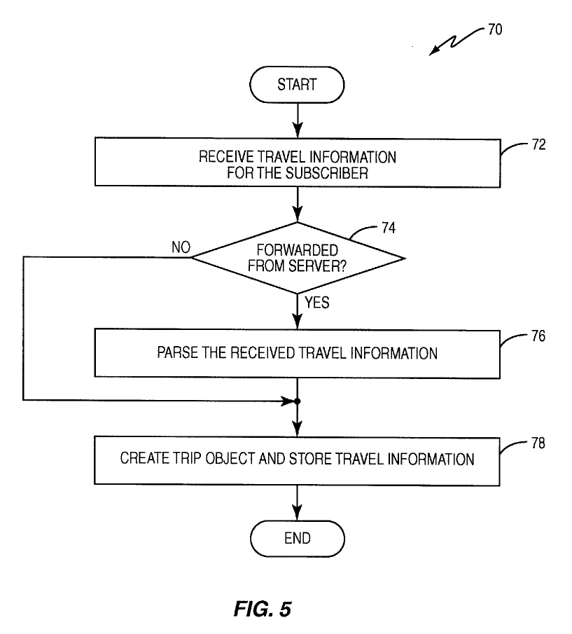

FIG. 5 is a flow chart illustrating a method 70 for creating one or more “trip objects.” A trip object is a software construct that stores information defining a single leg of a subscriber trip. The service logic 34 creates multiple trip objects to track and store the travel information for the entire subscriber trip. Method 70 begins when the service logic 34 receives information regarding a trip associated with the subscriber (box 70). Because the service logic 34 can receive this travel information in a variety of ways, the service logic 34 may first determine the method by which it received the information (box 74).

For example, the subscriber may manually enter travel information into a form on a web interface 32. Alternatively, a server 24 with which the subscriber interacts to make the travel arrangements may be configured to communicate the travel information directly to the service logic 34 using a predefined protocol. In such cases, the service logic 34 can easily map specific data to specific fields in a trip object. In other cases, however, the travel information comprises an itinerary. Because there is no standard format for generating an itinerary, the service logic 34 may need to parse itineraries to extract the desired travel information (box 76). A method by which the service logic 34 parses received itineraries is described in more detail later.

Regardless of how the service logic 34 obtains the travel information, however, the service logic 34 creates trip objects and populates them with user travel information (box 78). The service logic 34 will later compare the information in these trip objects to travel information stored in the trip object of one or more of the subscriber's friends to determine whether the subscriber and the friends will cross paths.

The present invention may store any type of travel-related information available. The following table illustrates some of that information; however, as those skilled in the art will readily appreciate, the information detailed below is for illustrative purposes only.

TABLE 3
Trip Object

| Field | Description |
|---|---|
| Internal ID | A unique identifier assigned to the user by the service. |
| | Not displayed to the user. |
| Leg ID | An identifier that identifies which leg of the trip the trip |
| | object is associated with. |
| Departure | This is a unique code that identifies the location from |
| Location | which the user is leaving (e.g., an airport code or a City |
| | code). |
| Departure Time | This is the time that the user leaves the departure |
| | location. |
| Arrival | This is a unique code that identifies the location in which |
| Location | the user is arriving (e.g., an airport code or a City code). |
| Arrival Time | This is the time that the user is estimated to arrive at the |
| | arrival location. |

As seen above, a trip object generated by the present invention defines the travel information for each leg of a subscriber trip. The Internal ID links the trip object to the subscriber, and is populated automatically by the service logic 34. The Leg ID may be an integer that identifies which leg of a trip that the object is associated with. The Leg ID field may, for example, begin at ‘1’ to indicate the first leg of a trip and increase accordingly. The Departure Location and Departure Time fields, as well as the Arrival Location and Arrival Time fields, define the place and time of the start and end of the leg.

The present invention classifies trips into one of two types: “away” trips and “home” trips. “Away” trips are defined as those trips where a subscriber leaves his or her home for some period of time. For example, a subscriber is on an “away” trip whenever he travels to another city. Away trips may be one-way or round trip, and may have one leg or many legs. The departure and arrival information for each leg is stored in a trip object as described above.

“Home” trips are defined as those periods of time in which a subscriber does not travel away from home, but instead, remains in his home area. Generally, “home” trips occur between “away” trips. Home trips may or may not have trip objects associated with them. As described in more detail later, the present invention classifies trips as being home or away because it employs different calculations to determine whether the subscriber and a given friend will be located near each other at substantially the same time for a predetermined period.

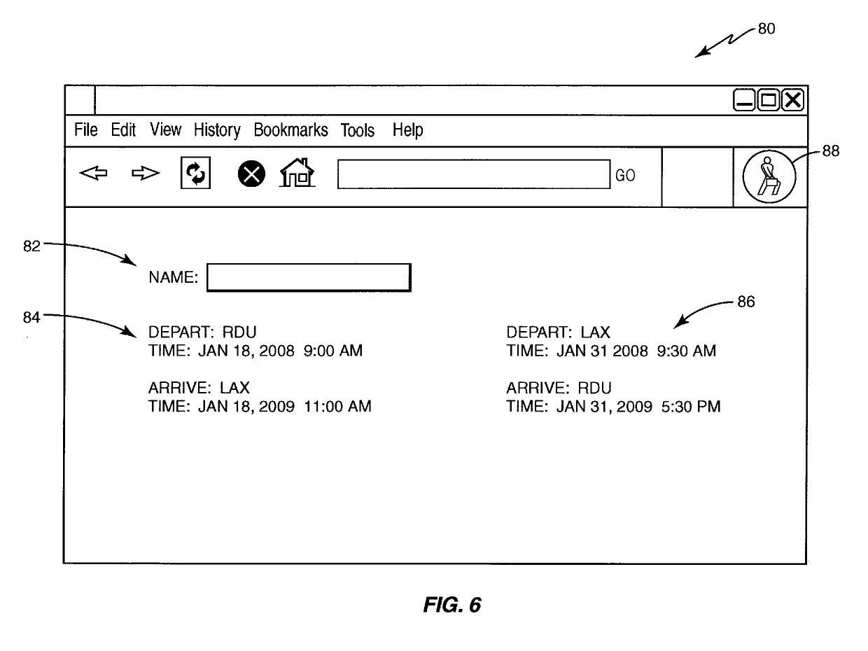

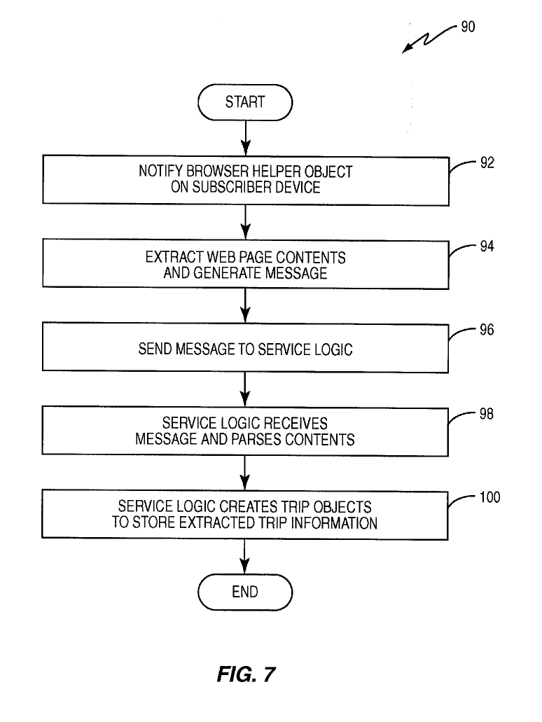

As stated above, the service logic 34 may need to perform a parsing function to extract travel information. Generally, the need to perform the parsing function is driven by the non-standard formatting of an itinerary or electronic confirmation. Although travel information is similar, each itinerary can be different because it may be generated by any of a variety of different providers, such as travel agencies or airlines, for example. Given the number of possible different formats, and the fact that existing formats may change or new formats may be added, there is a chance that the parsing function might extract incorrect data, or extract no data at all. Therefore, as seen in FIGS. 6 and 7, the present invention provides a communication mechanism by which the subscriber may forward travel information to the service logic 34 in a standard format.

Particularly, the subscriber may download and install a small application program known as a “browser helper object” onto their subscriber device 14, 16, 18, 20. A browser helper object is a plug-in that integrates additional functionality into the browser. Service providers, users, and/or third party vendors, for example, can provide such browser helper objects to integrate new functions into the browser window, as well as new controls, menus, and menu items to control the added functionality.

FIG. 6 illustrates a browser window 80 configured with a browser helper object according to one embodiment of the present invention. The client application that displays and operates the browser window 80 usually executes locally on the subscriber's device 14, 16, 18, 20. However, an external server provides the information displayed within the browser window 80. In this embodiment, server 24 communicates travel information to the browser application using the HyperText Markup Language (HTML) for display to the subscriber. Such information is generally available to the subscriber as an itinerary once the subscriber books a trip. The information includes fields for the subscriber's name 82, departure information 84, and arrival information 86. As seen in FIG. 6, the departure and arrival information 84, 86 comprise airport codes for the departure and arrival locations, as well as data and time information for the departure and arrival times; however, other trip-related information may also be displayed.

The browser helper object also provides a control button 88 that is integrated into the browser window 80. When the subscriber actuates control button 88, the browser helper object sends a copy of the HTML source code of the screen the subscriber is currently viewing to the service logic 34 via IP network 12. Because HTML is well known, the service logic 34 will be able to easily parse the HTML code by identifying predefined tags and extract the associated data.

FIG. 7 illustrates a method 90 in which a subscriber client device 14, 16, 18, is configured to communicate a subscriber's travel information using a browser helper object according to one embodiment of the present invention. Method 90 assumes that the subscriber has booked a trip with a server 24 and is viewing a display screen that displays the travel information.

Method 90 begins when the subscriber activates control button 88. This action generates a signal that invokes the browser helper object (box 92). In response, the browser helper object extracts the HTML contents of the web page the subscriber is currently viewing, and generates a service message for the service logic 34 (box 94). For example, in one embodiment, the browser helper object makes a copy of the HTML source code of the web page and includes it in the service message. The HTML source code includes tags and data that identify the departure and arrival information for the subscriber's trip. Additionally, the browser helper object may also insert the URL of the web page into the message so that the service logic 34 can identify the source if needed. In some embodiments, the browser helper object also includes the subscriber Internal ID, which may be stored in memory of the subscriber device 14, 16, 18, 20 to identify the subscriber. The browser helper object then sends the service message to the service logic 34 (box 96). Upon receipt, the service logic 34 determines whether the message contains a subscriber itinerary, and if so, parses the HTML source code to extract the subscriber's travel information (box 98). The service logic 34 then creates one or more trip objects, and populates the trip objects using the extracted data (box 100).

The browser helper objects according to the present invention are particularly beneficial because they provide a subscriber's trip information to the service logic 34 in a standard format. This allows the service logic 34 parsing function to process a wide array of different itinerary formats without having to know any of the formats a priori. Thus, with the present invention, there is less of a chance that the service logic 34 will incorrectly parse an itinerary having an unknown format for its data.

For example, many travel providers produce itineraries as HTML tables having multiple rows and columns. These tables would be sent to the service logic 34 in the HTML source code when the subscriber activates the browser helper object as previously described. Although the specific content of the HTML tables may vary, the service logic 34 is configured to advantageously exploit some commonalities between these tables to determine whether a given HTML table includes an itinerary. A row in a table that contains an itinerary, for example, may have predetermined column labels such as “Date,” “Depart,” and “Arrive.” If such labels are contained in the table, then the columns in subsequent rows might contain the specific information for the legs of a trip. The service logic 34 is configured to find these tables, if they exist, and extract the associated information.

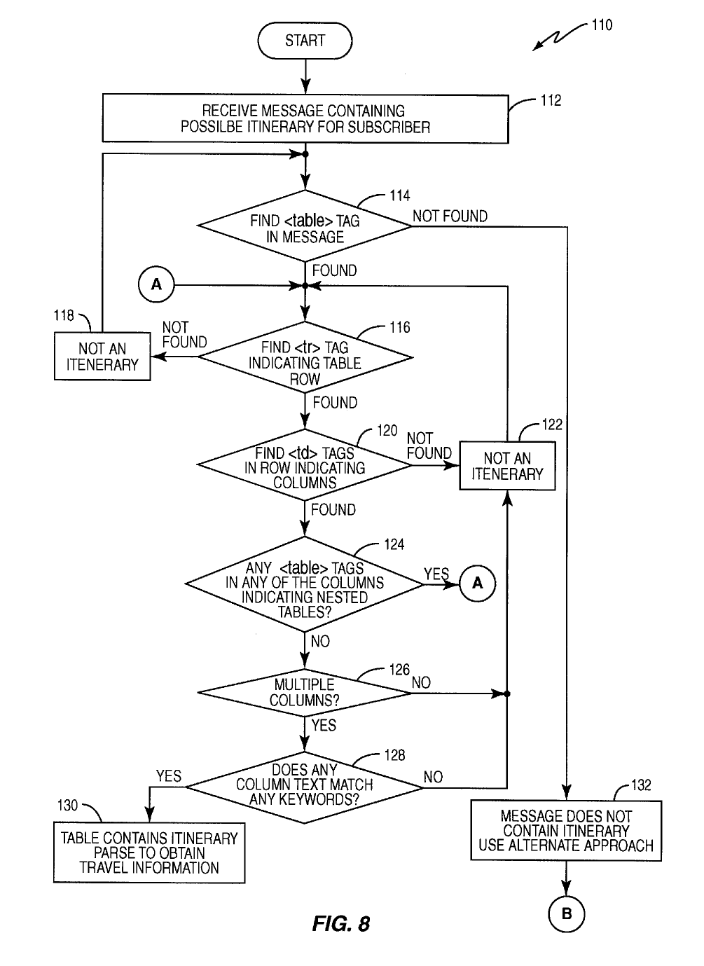

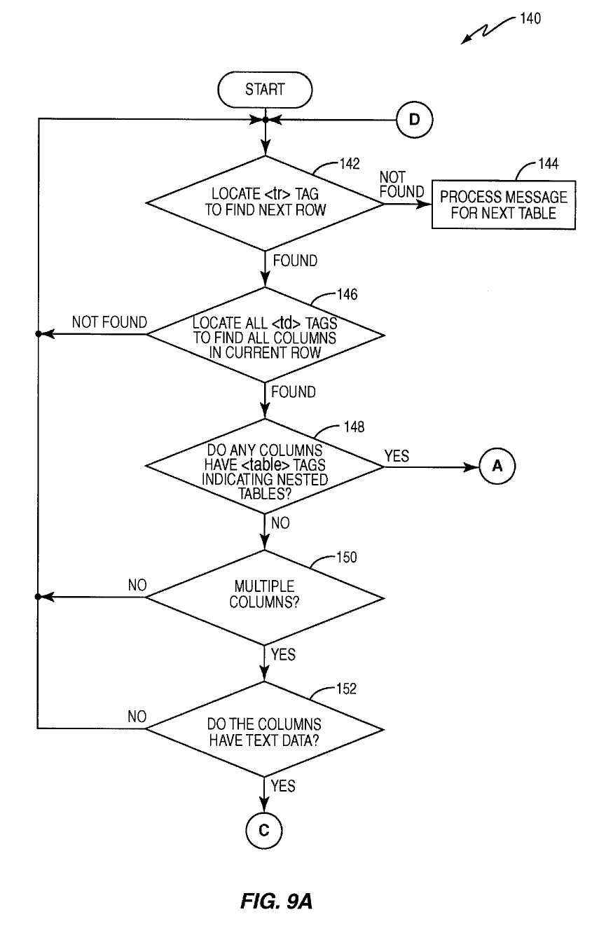

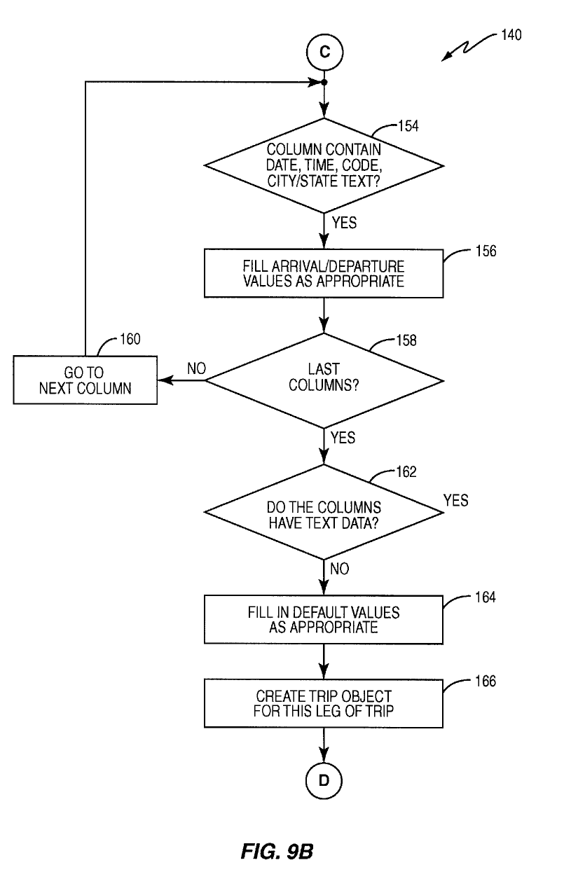

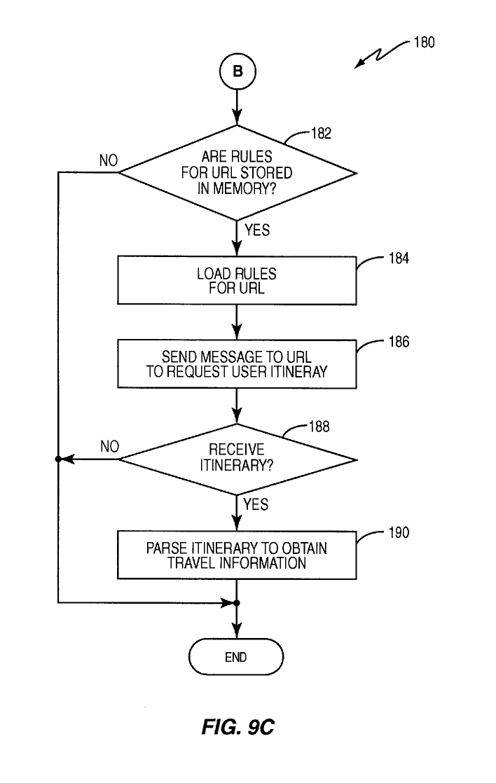

As seen in FIGS. 8 and 9, the present invention first determines whether the encapsulated HTML source code received in a message contains an itinerary (FIG. 8). If the HTML source code received with a message contains an itinerary (FIGS. 9A-9B), the present invention parses the itinerary to obtain the travel information. If the HTML source code does not contain an itinerary, the service logic 34 will attempt to access a URL of a travel provider directly to obtain the itinerary for the subscriber (FIG. 9C).

As seen in FIG. 8, method 110 begins when the service logic 34 receives a message containing a possible itinerary for the subscriber (box 112). In this embodiment, the message includes the HTML source code having at least one HTML table. The following code snippet provides an exemplary portion of the HTML source code that the service logic 34 is like to receive in this embodiment.

```
<table cellpadding=“2” cellspacing=“1” border=“0” width=“490”>
  <tr class=“arialBold11” valign=“bottom” align=“left”>
    <td height=“30” width=“100”>Date</td><td height=“30” width=“20”>Flt</td>
    <td height=“30” width=“170”>Depart</td><td height=“30”
      width=“170”>Arrive</td><td height=“30” width=“30”>Stops</td>
  </tr>
  <tr class=“arial11” valign=“top” align=“left”>
    <td><img border=“0” height=“2” width=“75” src=“../images/sec_remove_eng.png” />
      </td><td align=“left”><img border=“0” height=“2” width=“20”
      src=“../images/sec_remove_eng.png” /></td><td><img border=“0” height=“2”
      width=“165” src=“../images/sec_remove_eng.png” /></td><td><img border=“0”
      height=“2” width=“165” src=“../images/sec_remove_eng.png” /></td>
    <td align=“center”><img border=“0” height=“2” width=“35”
      src=“../images/sec_remove_eng.png” /></td>
  </tr>
  <tr class=“arial11” valign=“top” align=“left”>
    <td width=“100”> 11 Feb 04</td><td align=“left” width=“20”>209</td><td
      width=“170”>New York, JFK 11:20am</td><td width=“170”>Long Beach, CA
      2:30pm</td><td align=“center” width=“30”>0</td>
  </tr>
</table>
```

The service logic 34 executes a search through the HTML code to determine whether the HTML source code includes a table. In HTML, tables are identified by the <table> tag. Thus, the service logic 34 searches the HTML source code for a “<table>” tag. Any attributes associated with the <table> tag, such as “cellpadding” and “cellspacing,” are ignored. If a <table> tag is not found (box 114), the service logic 34 can assume that the HTML source code does not include an itinerary (box 132). In such cases, as described below in more detail, the service logic 34 may attempt an alternative method to obtain the travel itinerary. Otherwise, if a <table> tag is found, the service logic 34 will locate the rows in the table.

HTML uses <table> tags to indicate the rows in a table. As such, the service logic 34 looks for one or more “<tr>” tags within the <table> tags (box 116). As above, any attributes associated with the <tr> tags such as “class” and “align” are ignored. If there are no rows (i.e., no <tr> tags are found), the table does not contain an itinerary (box 118) and the service logic can search the message for the next occurrence of a table (box 114). Otherwise, the service logic 34 will locate the columns in the row. HTML uses <table> tags to mark the start of a column; therefore, the service logic 34 will locate the “<td>” tags to determine whether the current row has columns (box 120). If there are no columns (i.e., no <td> tags), the current row does not include an itinerary (box 122) and the service logic 34 returns to locate the next row (box 116). If there are columns, the service logic 34 assumes that any remaining text is data that would be displayed to the subscriber. [Each column in the current row is thus processed to determine its contents.] As above, any attributes associated with <td> tags are ignored; however, with HTML, tables may be nested to any arbitrary depth. Therefore, the present invention will not ignore any subsequent occurrences of a <table> tag within the columns. If there are any subsequent <table> tags within the columns (box 124), the service logic 34 recursively processes those tables to determine whether an itinerary exists within the nested tables.

The service logic 34 then determines whether the current row has multiple columns (box 126). If not, the service logic 34 assumes that no itinerary exists and repeats the process for the next row (box 116). If there are multiple columns, the service logic 34 will compare the text within each of the columns to determine the presence of keywords indicating an itinerary (box 128). By way of example, the columns may include keywords such as “Date,” Depart,” and “Arrive.” If there are any occurrences of the predetermined keywords, the service logic 34 concludes that the received message includes an itinerary and sends the table to the parser (box 130). If not, the service logic 34 determines that the columns do not contain itinerary information and searches for the next row (box 116). This process continues until the service logic 34 determines that an itinerary does or does not exist.

If an itinerary exists, the service logic 34 will parse the itinerary to extract the information. FIGS. 9A and 9B, for example, are flow diagrams illustrating one exemplary approach in which the service logic 34 parses an HTML itinerary. Method 140 begins with the service logic 34 advancing to the next row in the table (box 142). As above, the service logic may search for a <tr> tag that denotes rows in HTML. If no more rows are found, the received message is processed for the next table as previously described (box 144). Otherwise, the service logic 34 locates all columns for the current row by searching for one or more <td> tags within the row (box 146). If there are no columns, the service logic 34 simply advances to the next row (box 142). Provided columns are found, the service logic 34 tests each column to ensure that none include a nested table (box 148). As above, the service logic 34 may search the columns for a <table> tag. If any columns do contain a nested table, the service logic recursively processes that nested table before returning to process the remaining columns.

The service logic 34 then determines whether the current row contains multiple columns (box 150), and if so, whether any of the columns contain data that might be interpreted as travel information (box 152). If the current row does not have multiple columns, or none of the columns contains possible travel information, the service logic 34 simply advances to the next row (box 142). Otherwise, the service logic 34 extracts the text from the columns and creates a trip object to store that text.

As seen in FIG. 9B, the service logic 34 tests each column for a variety of different types of data. In this embodiment, the service logic 34 tests each column to determine whether it contains a date, a time, a location code such as an airport code, or a city and state indicator (box 154). The service logic 34 may test, and extract, other data as needed or desired. If a column contains any of this data, the service logic 34 populates the appropriate arrival or departure values of the trip object (box 156). All data not of these types is ignored.

For example, the service logic 34 will generally extract a departure date, and an arrival date, for each leg of a trip. During processing, the service logic 34 may locate and extract multiple dates, but have no way of distinguishing whether a given date is a departure date or an arrival date. However, itineraries generally list the departure information prior to the arrival information. Therefore, in one embodiment, the service logic 34 assigns the first extracted date as the departure date and the second extracted date as the arrival date. In another embodiment, the service logic 34 compares the two dates, and assigns the earlier date as the departure date and the later date as the arrival date. If there is only one date, the service logic 34 assigns it as the departure date and leaves the arrival date empty until parsing is complete. If another date is found, it may be assigned as the arrival date. If none is found, a default arrival date may be used. Similar comparison processes may be performed to assign departure and arrival times, as well as departure and arrival locations.

If the service logic 34 has not reached the last column in the current row (box 158), the service logic 34 advances to the next column and repeats the information extraction process (box 160). Otherwise, the service logic 34 determines whether it has all the information it requires to define a leg of a trip (box 162). If not, the service logic 34 fills the empty values in the trip object with default information (box 164). By way of example, where the service logic 34 extracted only a departure date, the service logic 34 could assume that the subscriber would arrive at the location the same day and assign the departure date as the arrival date. Alternatively, the service logic 34 could employ user-specified values or rules to fill in blank data. In another example, the service logic 34 might only have extracted enough information to define one leg of a trip. In these cases, the service logic 34 might assign the user specified information to define a return leg for the trip. Once the service logic 34 contains all the extracted information it requires to define a leg of a trip, the service logic 34 stores the trip object (box 166) in memory and advances to the next row.

As previously stated, the service logic 34 may receive messages that do not contain an itinerary for one reason or another. For example, some providers may employ a different non-standard protocol for their itineraries. Alternatively, the message may contain an itinerary with tags or labels not recognized by the service logic 34. Therefore, when the message does not contain an itinerary, the service logic 34 will attempt to obtain an itinerary for the user using alternative means. FIG. 9C illustrates one such method 180 by which the present invention attempts to obtain an itinerary for the subscriber. Particularly, the service logic 34 has access to a set of stored rules or profiles that define parsing rules for providers that employ non-standard protocols

As previously stated, the received messages containing the HTML tables may include a Universal Resource Locator (URL) that identifies the provider's site from which the subscriber's device 14, 16, 18, 20 copies the HTML source code. Based on the domain portion of the URL, the service logic 34 can load a specific set of parsing rules stored in local memory at server 26 or DB28. The service Logic 34 can then use the received URL to request an itinerary from the provider's site. In this manner, the service logic 34 can handle special formats and parse those formats to retrieve the travel information.

Method 180 begins with the service logic 34 loading the special rules for a provider identified by the URL in the received message (boxes 182, 184). If there are no special rules in memory for the provider, the method ends. Otherwise, once loaded, the service logic 34 generates a request message for the subscriber itinerary, and sends the message to the URL (box 186). If the service logic 34 receives an itinerary (box 188), the service logic 34 uses the rules to parse the information and retrieve the itinerary (box 190). Otherwise, the process ends.

During the parsing process, the service logic 34 may encounter a wide variety of data types in a wide array of formats. Therefore, the service logic 34 may be configured to recognize each type of data in any of the different formats. The following tables illustrate some of the types of data and their formats that the service logic 34 is configured to detect and extract.

Table 4 illustrates some of the formats itineraries may use to represent departure and arrival dates.

TABLE 4
Date formats

| | |
|---|---|
| ddmmmyy | mmm dd yy |
| ddmmmyyyy | mmm dd yyyy |
| dd mm yy | mmm dd, yy |
| dd mm yyyy | mmm dd, yyyy |
| mmm dd | |

Particularly, “dd” represents a day, “mmm” represents a month, and “yy” and “yyyy” represent a two-digit year and a four-digit year, respectively. Some may include an abbreviation indicating the day of the week. Generally, for two-digit years, the service logic 34 is configured to assume the current century; thus, a two-digit year represented as ‘08’ in the itinerary would be reformatted to appear as ‘2008’ in the trip object. If a year is omitted entirely, but includes a month and a day value, the service logic 34 formats a new date with the current year unless the extracted month occurs earlier in time than the current month (e.g., December occurs “earlier in time” than January). In such cases, since a subscriber cannot travel “back” through time, the service logic 34 formats a new date with the next year. Finally, some itineraries list a single date for the departure date and the arrival date. In these cases, the service logic 34 assumes that they are the same date.

Table 5 illustrates some of the formats itineraries use to represent departure and arrival times.

TABLE 5
Time formats

| | |
|---|---|
| hh:mm xx | hh:mmxx |
| h:mm xx | h:mxx |

In the table, “hh” represents the hour, “mm” represents the minute, and “xx” represents “AM” or “PM.” The AM and PM indicators may or may not be capitalized. The hour, the minute, and “AM” or “PM” indicators may be represented in the itinerary as one digit or two. Therefore, the service logic 34 should be configured to recognize and extract times appearing in any of these formats, and to save them in a “hh:mm:xx” format.

Table 6 illustrates some of the formats itineraries use to represent the various airports.

TABLE 6
Airport Code formats

| | |
|---|---|
| RDU | Raleigh/Durham International Airport |
| JFK | John F. Kennedy International Airport |
| LAX | Los Angeles International Airport |
| EWR | New York - Newark Liberty International Airport, |

Airports around the world are commonly referred to by a unique three-letter code. This code is called the International Air Transport Association (IATA) Location Identifier. Often, this code comprises uppercase letters that appear in the itinerary between parentheses (e.g., (RDU)). Other times, the code appears without parentheses, but after a comma or other punctuation. Therefore, the present invention maintains a list of these codes and their descriptions. Whenever the service logic extracts a three letter code, it is compared to the list. A match indicates that the extracted label is a valid airport code. Those skilled in the art will appreciate that the present invention is not limited only to the use of IATA codes or three-letter codes. Airport codes may be represented by more or less than three uppercase letters as needed or desired.

Additionally, the present invention is not limited to the use of airport codes to describe departure and arrival locations. In some embodiments, the itineraries do not explicitly include an airport or other code to define an arrival and/or a destination location. Instead, some itineraries might provide a city and/or a state to define one or both of the arrival and destination locations. Table 7 illustrates some of the formats that the service logic may encounter when parsing the itinerary, and thus, is configured to recognize and extract.

TABLE 7
City and State formats

| | |
|---|---|
| City, SS | City SS |
| City, State | City State |

States may be indicated by their two-letter abbreviation, or they may be spelled out. In addition, commas and/or other punctuation may appear in the itineraries.

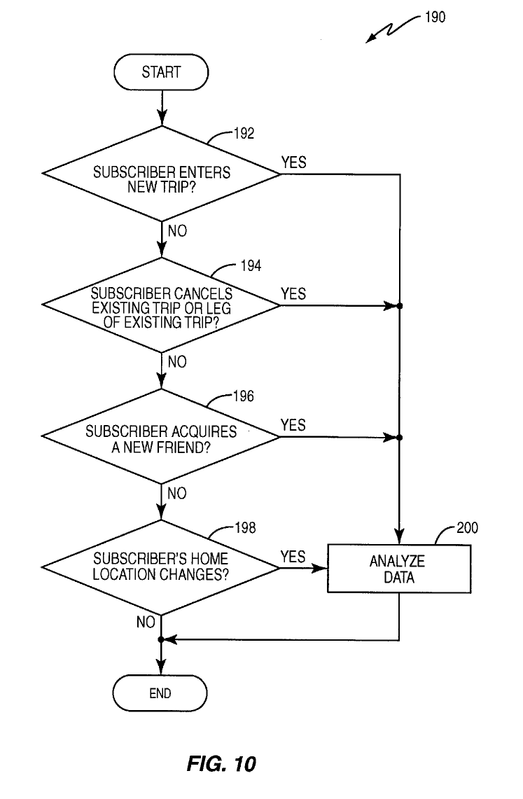

As previously stated, the service logic 34 obtains and stores the trip data for the subscriber, and then analyzes this data to determine whether the subscriber and a friend will be within a predefined radius of each other for some predefined amount of time. FIG. 10 is a flow chart illustrating some of the possible triggers that could cause the service logic 34 to perform this function. As seen in method 190, the service logic 34 receives an indication whenever a subscriber enters trip information for a new trip (box 192), cancels an existing trip (box 194), acquires a new friend through the service (box 196), or changes his home location or alters his subscriber preferences (box 198). If the service logic 34 detects any of these predetermined events, the service logic 34 will analyze the subscriber's trip data (box 200). It should be noted that updates made to a trip are treated as if the existing trip was cancelled and a new trip was entered.

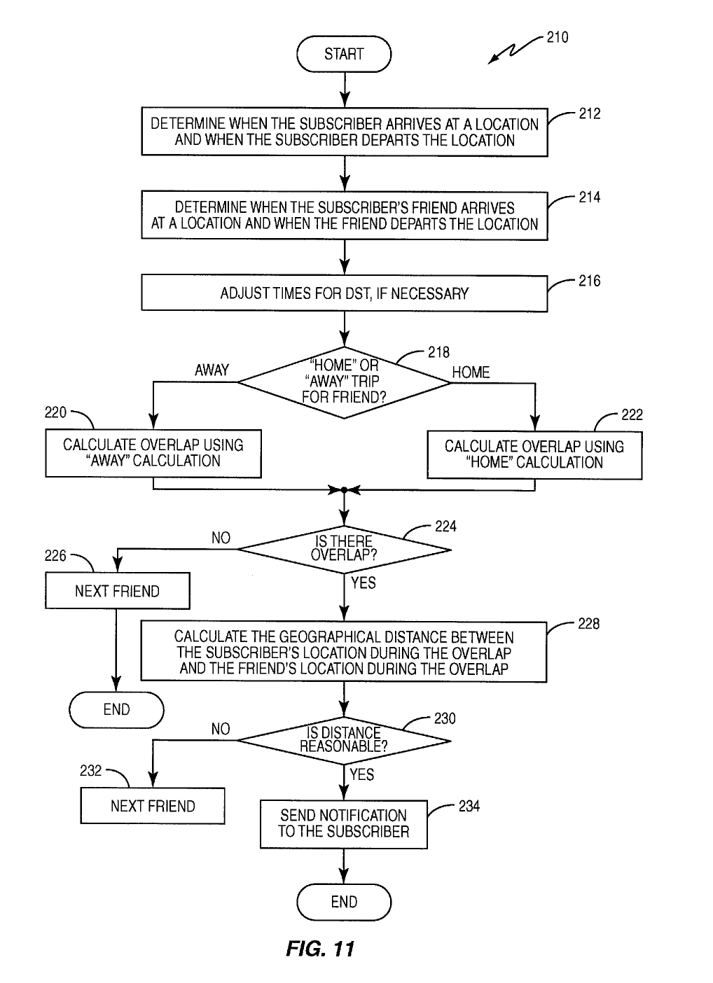

FIG. 11 is a flow diagram illustrating a method 210 in which the service logic 34 determines whether a subscriber will be geographically near a given friend for a predetermined period of time. There are different scenarios with which the present invention may operate to inform a subscriber and/or a friend. However, in a first scenario, the service logic 34 analyzes the trip data and informs the subscriber that he might possibly cross paths with an identified friend.

Method 210 begins by analyzing the subscriber's trip data and comparing it to the friend's trip data responsive to the detecting one of the predetermined events. The service logic 34 accesses the subscriber's trip data and calculates a first time value representing the length of time that the subscriber will be at a location. Generally, the first time value is the elapsed time between the subscriber's arrival at a location and the subscriber's departure from the location (box 212). The subscriber's location is described using an airport code. The service logic 34 also accesses the friend's trip data and calculates a second time value that represents the length of time that the friend will be at a location. Generally, the second time value is the elapsed time between the friend's arrival at and departure from a location (box 214). As above, the friend's location may be defined by an airport code that is the same or different from the subscriber's airport code. If necessary, the service logic 34 may adjust the first and second time values to reflect a standard time zone and/or Daylight Savings Time (DST) (box 216); however, in most embodiments, the departure and arrival times are converted and stored in a standard format during parsing, thereby negating the need for subsequent adjustments.

Once calculated, the service logic 34 tests the first and second time values to determine if they overlap. Overlapping values would indicate that both the subscriber and the friend would be in some location at nearly the same time. To determine overlap, the service logic 34 will first determine whether the friend's trip data constitutes an “away” trip or a “home” trip (box 218). As previously described, “away” trips are those excursions away from a home area. For an “away” trip, the service logic 34 performs an away trip calculation to determine whether the first time value overlaps the second time value (box 220). “Home” trips are not really “trips” away from a home area, but instead, are those periods of time during which a subscriber (or friend) remains in his home area. Generally, “home” trips occur between “away” trips. For a “home” trip, the service logic 34 performs a home trip calculation to determine whether the first time value overlaps with the second time value (box 222). Both the home and away trip calculations will be described in more detail.

If the times do not overlap (box 224), the service logic 34 will move to another of the subscriber's friends, if any, and perform the same process (box 232). Otherwise, the service logic 34 will determine whether the subscriber and the friend will be geographically near each other during the overlap time. As seen in FIG. 11, the service logic 34 will calculate the geographical distance between the subscriber's location during the overlap time and the friend's location during the overlap time (box 228). If the computed distance is within the maximum reasonable distance predefined by the subscriber (box 230), the service logic 34 will generate a “matched trip” object, which is described later in more detail, and send a notification to the subscriber (box 234). If the computed distance is greater than the predefined maximum distance, the service logic 34 does not generate a “matched trip” object or alert the subscriber. Instead, the service logic 34 will select another of the subscriber's friends and begin the process again (box 232). The method 210 may continue until the service logic 34 has compared the subscriber's trip data to all of the subscriber's friends.

As stated above, the service logic 34 will calculate the time overlap using either a “home” calculation or an “away” calculation. Any of a variety of formula may be used for the calculations; however in one embodiment, the “away” calculation is performed using formula (1):

overlap=min(user's departure time, friend's departure time)−max(user's arrival time, friend's arrival time) (1)

Particularly, the service logic 34 considers the earliest of the departure times and subtracts from that the latest of the arrival times. The resultant value, which is termed herein as “overlap,” is then compared against the minimum overlap minutes predefined by the subscriber. If the overlap value is less than the minimum number of overlap minutes predefined by the subscriber, the service logic 34 determines that the subscriber and the friend will not be near each other for a long enough period of time. If the overlap value is greater than or equal to the minimum number of overlap minutes predefined by the subscriber, however, the service logic 34 determines that an overlap of sufficient length of time exists. An overlap value of zero (0) indicates that no overlap exists at all.

Similarly, any of a variety of methods may be used to perform the “home” calculation. In one embodiment, the service logic 34 employs an array. The array is generated to include one array element for each minute of time that exists between the subscriber's arrival time and the subscriber's departure time at a given location. For example, if there were a 60 minute “layover” between an arrival time and a departure time, the array would be generated to have 60 elements.

The service logic 34 initializes each array element to a predetermined value, such as ‘1,’ for example. Then, for each minute that the friend's trip overlaps the time period between the subscriber's arrival and departure, the service logic 34 sets a corresponding array element to another predetermined value, such as ‘0.’ Then, the service logic 34 counts the remaining array elements that have a value of ‘1.’ If that number is less than the number of the subscriber's predefined minimum overlap minutes, the service logic 34 determines that the subscriber and the friend will not be near each other for a long enough period of time. If the number of elements having a ‘1’ is greater than or equal to the number of overlap minutes predefined by the subscriber, the service logic 34 determines that a sufficiently long overlap exists. If there are no ‘1’ in the array, then there is no overlap at all.

There are also various mechanisms available to determine distances between two points. In one embodiment, the present invention maintains the latitude and longitude of each arrival and departure location defined by the subscriber and/or the subscriber's friends. Given this information, the service logic 34 computes the distance between two points, and then converts that answer into U.S. miles.

distance=sin(latitude of user's location/DtoR)*sin(latitude of friend's/location/DtoR)+cos(latitude of user's location/DtoR)*cos(latitude of friend's/location/DtoR)*cos(abs(longitude of friend's location−longitude of user's location)/DtoR);

miles=3959*a tan(sqrt(1.0−distance²))/distance;

where DtoR is a constant representing the number of degrees in a radian (i.e., 180/π or ≈57.29578).

The service logic 34 might also inform the subscriber's friend based on the calculations required to notify the subscriber. The steps for notifying the friend would be the same as those discussed for FIG. 11. However, rather than test the calculated overlap value and the distance against the subscriber's predefined preferences, the service logic 34 would compare them to the friend's predefined preferences. If the calculated overlap value meets or exceeds the friend's predefined minimum overlap, and if the calculated distance between the subscriber and the friend is within the maximum reasonable distance as defined in the friend's preferences, the service logic 34 will also create a “matched trip object” for the friend and send a notification to the friend.

The present invention is not limited to comparing the data of two subscribers that are on “away” trips (i.e., traveling away from home). In another embodiment, the service logic 34 compares the trip data of a subscriber on an “away” trip with the trip data of a friend on a “home” trip. Particularly, the service logic 34 will calculate the overlap values for the subscriber and the friend as previously described. In this case, however, the subscriber's location comprises an airport code, while the friend's location comprises an address or city/state combination indicating the friend's home. Once calculated, the service logic 34 determines whether the calculated times overlap using the “home” calculation, and whether the geographical distance that separates the subscriber and the friend is within the subscriber's predefined maximum distance as previously stated. The service logic 34 might also perform the same function for the friend. Based on the friend's preferences, the service logic 34 could also notify the friend.

Additionally, the service logic 34 compares the trip data for a subscriber who stays at home with the trip data of a friend who is traveling. The subscriber's location might be the subscriber's home (e.g., City State), while the friend's location might be an airport code. The service logic 34 would perform the home calculation on the trip data to determine whether any overlap exists, and then determine the geographical distance between the subscriber and the friend. If that distance is at or below the maximum threshold predefined by the subscriber in the subscriber preferences, then the service logic 34 will notify the subscriber.

It should be noted that the service logic 34 will not attempt to compare trip data between the times when a subscriber departs a location and arrives at another location. This is because during such times the person is not available. By way of example, a person who flies from one location to another is not available while he is “in-flight.” Therefore, the service logic 34 will not compare that subscriber's trip data with friends' trip data between the departure time and the arrival time.

As previously described, the service logic 34 generates a “matched trip object’ each time it determines that the subscriber and a friend will be geographically near each other for a sufficient amount of time, and places the object on a list. A matched trip object is a record that contains information associated with the match between the subscriber and a friend if the service logic 34 indicated that they will be near each other for a predetermined amount of time. A match trip object might include unique identifiers that identify the subscriber, the subscriber's trip, a friend, and a friend's trip. These identifiers are used to generate and send alert notifications to the subscriber and/or the subscriber's friends informing them that they will cross paths. Additionally, the identifiers may be used to determine whether any new trip, or changes to an existing trip, will affect those plans. That is, new trips or changes to existing trips might mean that the subscriber will no longer be located at a specific location at a specified time. In addition, they might increase or decrease the time that a subscriber is at a given location, or place the subscriber at new location altogether. In any case, the service logic 34 is configured to analyze these changes in light of the matched trip object to determine the effect of the new/edited trips on the subscriber and on the subscriber's friends.

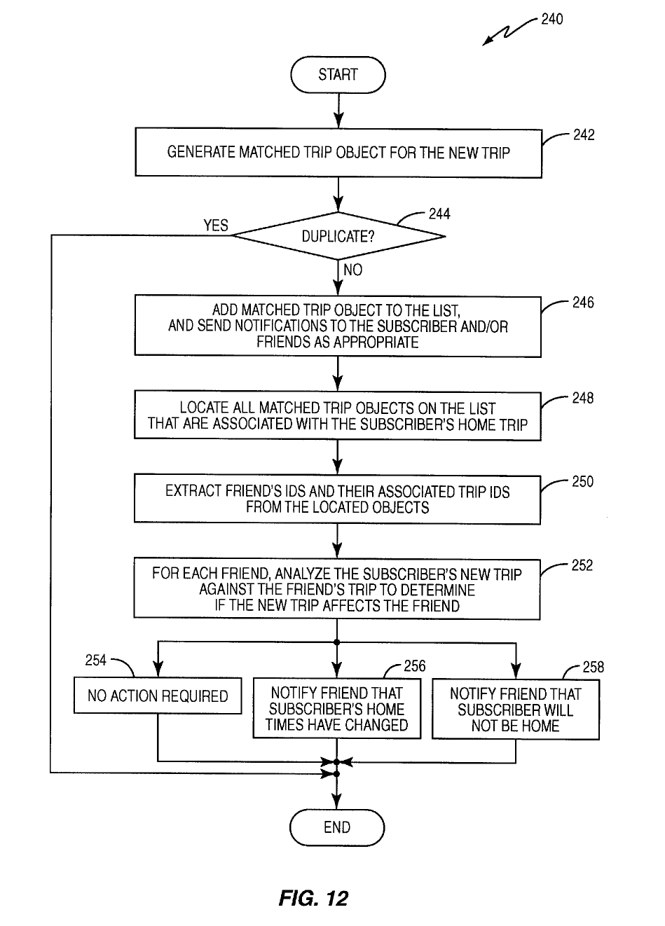

FIG. 12 is a flow diagram illustrating how the present invention analyzes a new trip to determine whether the trip affects any previous matches between a subscriber and a friend. This scenario might occur, for example, where a subscriber who had originally planned to be at home during a certain time (i.e., on a “home” trip) will no longer be home because of an unexpected trip.

In more detail, the service logic 34 analyzes the new trip information against the trip information of the subscriber's friends and generates a matched trip object (box 242) as previously described (see FIG. 11). The service logic 34 then checks the subscriber's list of matched trip objects to determine whether the list already contains a matched trip object for this trip (box 244). If so, the service logic 34 disposes of the newly generated information as a duplicate, but otherwise adds the new matched trip object to the list and sends email notifications as appropriate (box 246). Once the notifications are sent, the service logic 34 will determine whether the new trip will affect any of the previous matches between the subscriber and the subscriber's friends.

Particularly, the service logic 34 first locates all the matched trip objects on the subscriber's list that identify when the subscriber would be at home (i.e., when the subscriber would be on a “home” trip) (box 248). The service logic 34 would then extract the friend's identifier and the corresponding friend trip identifier from that object, and use them to access the matched trip object list for that friend (box 250). For each matched trip object that is found on the friend's list, the service logic 34 would re-analyze the associated trip information in light of the subscriber's new trip information (see FIG. 11) (box 252). There can be three possible results. If the process reveals that there is no time and/or geographical location overlap between the subscriber and the friend as the result of the new trip, no action is taken (box 254). If there is both time and geographical overlap that is suitable based on the subscriber's and/or the friend's predefined preferences, the service logic 34 will send an email to the friend notifying him of the subscriber's change (box 256). If a time and/or geographical overlap occurs but is insufficient to meet the thresholds of the subscriber and/or the friend, the service logic 34 will notify the friend of the change in the subscriber's travel plans (box 258).

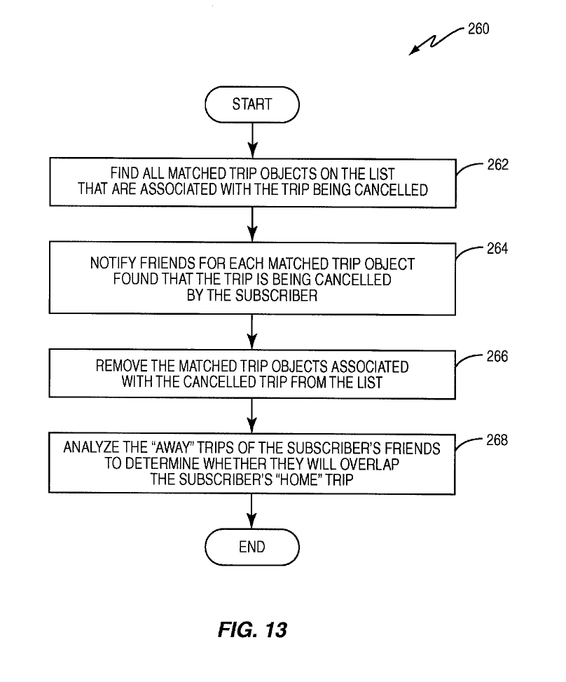

FIG. 13 illustrates how the present invention handles trip cancellations by a subscriber. Method 260 begins when, upon receiving a notification that a trip is cancelled, the service logic 34 locates all matched trip objects in the subscriber's list that are associated with the cancelled trip (box 262). The service logic 34 then sends notifications to the friend identified in the matched trip object to inform them that the subscriber has cancelled the trip (box 264), and deletes the matched trip object from the subscriber's list (box 266).

Note that the cancellation of the trip by the subscriber could mean that the subscriber will be home (i.e., on a home trip) for that period of time. Therefore, the service logic 34 could generate a new trip object for the subscriber's new “home” trip and analyze it against the “away” trips of the subscriber's friends as previously described (FIG. 11) (box 268). If the process reveals that one or more friends will be near the subscriber for some predetermined period of time, the service logic 34 would create new matched trip objects as described above and notify the subscriber and the affected friends.

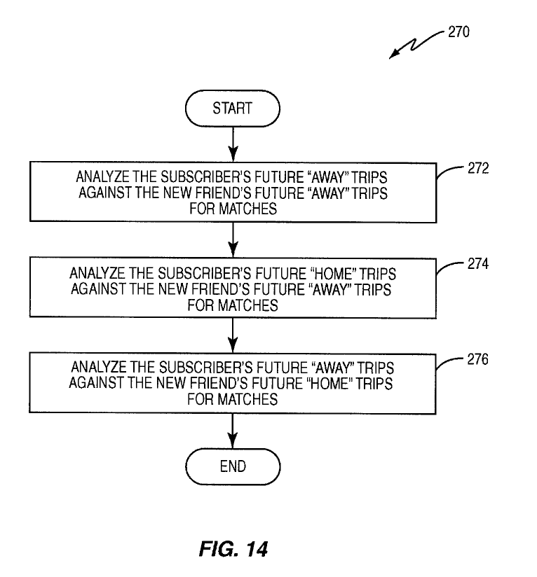

FIG. 14 illustrates how the present invention might handle the occasions where the subscriber acquires a new friend. Particularly, the service logic 34 will analyze the trips of the new friend against the subscriber's trips to determine if they will be near each other for at least some predefined period of time.

Method 270 begins with the service logic 34 using the previously described process (FIGS. 11A-11B) to determine whether the subscriber and the newly acquired friend will be near each other for at least a predefined period of time while they are both on a trip away from their respective home areas (box 272). The service logic will then use a similar process to determine if any of the new friend's trips will bring him near the subscriber for at least a predefined period of time while the subscriber is home (box 274). The service logic 34 then performs similar calculations to determine whether the subscriber will be near the new friend for at least a predefined period of time during one of the subscriber's “away” trips (box 276). As above, the service logic 34 generates and saves matched trip objects for each scenario.

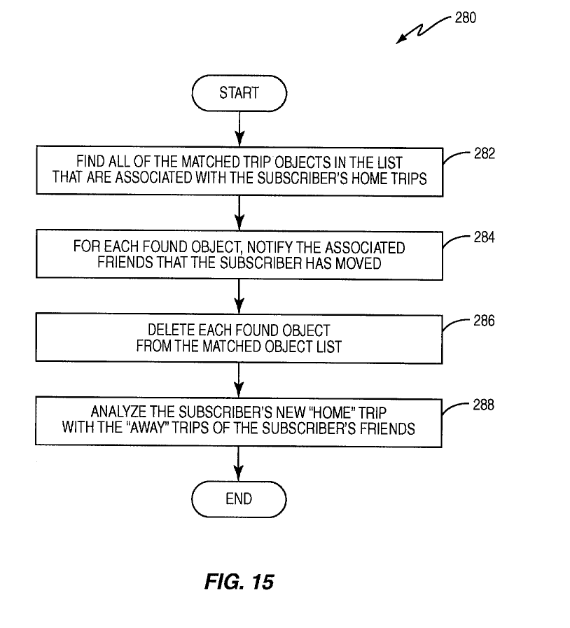

FIG. 15 is a flow diagram that illustrates a method 280 by which the present invention could handle changes to a subscriber's home location according to one embodiment. For example, if a subscriber were to move his residence, it would affect his location during a “home” trip. Depending on the distance the subscriber moves, it could also affect whether a friend who is currently traveling will or will not meet the subscriber.

Method 280 begins with the service logic 34 searching the subscriber's list for all the matched trip objects that are associated with the subscriber's “home” trips (box 282). For each found object, the service logic 34 will extract the friend identifiers and send notifications to those friends (box 284). The notifications might indicate, for example, that the subscriber has moved his home location and include the subscriber's new address or contact information. Once the notification is sent, the service logic 34 removes the matched trip objects from the subscriber's list (box 286), and creates a new “home” trip for the subscriber with the new information. The service logic 34 then analyzes the trip information according to the method previously described to determine whether any of the subscriber's friends will be near the subscriber for at least a predefined period of time (box 288).

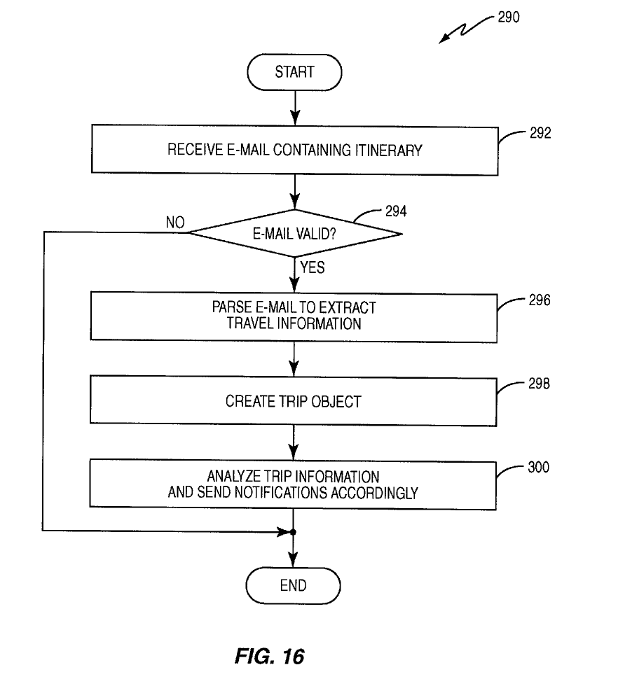

FIG. 16 illustrates a method 290 in which a user's travel itinerary is provided to the server 26 via e-mail according to one embodiment of the present invention. The following method may be used, for example, where a travel service provider allows a user to send e-mail containing trip itineraries to one or more user-specified e-mail addresses. If the user enters an e-mail address associated with the service or with the user, for example, the service logic 34 can parse the e-mail to extract the travel information from the travel itinerary.

Method 290 begins when a server associated with the service receives an e-mail that contains the travel itinerary for a user (box 292). The server that receives the e-mail may be, for example, server 26 or a Simple Mail Transfer Protocol (SMTP) server connected to server 26. The receiving server validates the email to ensure that the e-mail is associated with a registered subscriber (box 294). For example, in one embodiment, the receiving server checks the “TO” field of the received email message to determine whether the received e-mail is addressed to a registered subscriber. Registered subscribers would have unique e-mail addresses known to the service logic 34. In another embodiment, the receiving server would check the “FROM” field to determine whether a registered user sent the e-mail. This latter case might occur whenever a registered user forwards a received travel itinerary to the server from another e-mail account. If the e-mail is not received from a valid source, the receiving server could ignore the e-mail message (box 294). Otherwise, the server that received the e-mail would parse the e-mail contents to extract the travel information in the travel itinerary (box 296). Once parsed, the service logic 34 would use extracted travel information to create one or more trip objects as previously described (box 298). The service logic 34 would then analyze the trip information to determine whether the subscriber will be near any of his or her friends for at least a predefined period of time, and send out notifications as previously described (box 300).

The contents of the e-mail will generally be either HTML or plain text. Other formats (e.g., XML) may also be used, however, HTML and text are mentioned for illustrative purposes. For e-mails that contain a travel itinerary in an HTML format, the service logic 34 will parse the travel itinerary to extract the travel information as previously described. If the e-mail contains a travel itinerary that is in plain text, the service logic 34 will employ a slightly different process. Particularly, the service logic 34 will still search for the existence of a table containing the travel information. However, rather than search for HTML “tags,” the service logic 34 will search for other indicators.

For example, the service logic 34 may analyze the e-mail for the presence of pre-defined delimiters, such as the character “|” or a “whitespace” (e.g., one or more blank spaces). These delimiters may separate the cells of a table or indicate the presence of travel information. Additionally, the service logic 34 could search the travel itinerary for the presence of some pre-defined labels, such as “Date,” Depart,” “Departure,” or “Routing Details.” Typically, each of the labels that define a leg of a trip will be located in a single line. Likewise, the information associated with those labels will be in the next line. Provided one or more of the lables are found, the service logic 34 would then analyze the text in the next row of text to determine the travel information associated with those labels. Characters used to represent a table grid (e.g., “+−−−−−−−+−−−−−−−+”) would be ignored.

In addition, the service logic 34 could search a text e-mail for travel information in specific formats. As stated above, these include, but are not limited to, departure times and places, arrival times and places, city and/or airport codes, and state codes, all of which can have a format as previously described. Although they may have varying formats, the service logic 34 could be configured to recognize and extract each as previously described. In cases where the service logic 34 des not recognize the information, the service logic 34 could request the travel information as previously described using a URL included with the received e-mail.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of matching subscriber presence in a social network, the method comprising:
maintaining travel information for a subscriber and for one or more friends in a social network of the subscriber;
determining whether the subscriber will be geographically near a friend for at least a predetermined length of time by comparing the travel information associated with the subscriber with the travel information associated with the friend; and
generating a notification message for the subscriber based on the determination.

2. The method of claim 1 wherein determining whether the subscriber will be geographically near a friend for at least a predetermined amount of time comprises:
calculating a length of time that the subscriber will be located at a first location while the friend will be located at a second location; and
if the length of time equals or exceeds a subscriber-specified time value, calculating a distance between the first and second locations.

3. The method of claim 2 wherein calculating the length of time comprises selecting a formula to perform the calculation based on whether the subscriber is traveling away from the subscriber's home area.

4. The method of claim 2 wherein calculating the length of time comprises selecting a formula to perform the calculation based on whether the friend is traveling away from the friend's home area.

5. The method of claim 2 wherein generating a notification message for the subscriber based on the determination comprises generating the notification message if the length of time equals or exceeds the subscriber-specified time value, and if the calculated distance does not exceed a subscriber-specified distance value.

6. The method of claim 5 further comprising generating another notification message for the friend if the calculated length of time equals or exceeds a friend-specified time value, and if the calculated distance does not exceed a friend-specified distance value.

7. The method of claim 1 further comprising:
determining whether the subscriber will be geographically near the friend for at least a predetermined length of time based on subsequently provided travel information associated with at least one of the subscriber and the friend; and
notifying at least one of the subscriber and the friend if the subsequently provided subscriber travel information indicates that the subscriber will no longer be within a predetermined distance of the friend for at least a predetermined length of time.

8. The method of claim 1 further comprising:
receiving an electronic travel itinerary comprising the travel information for the subscriber; and
parsing the electronic travel itinerary to extract the travel information for the subscriber without manual entry of the travel information by the subscriber.

9. The method of claim 8 wherein the electronic travel itinerary comprises a table having rows and columns, and wherein parsing the electronic travel itinerary further comprises extracting the travel information from the rows and columns.

10. The method of claim 8 wherein the travel itinerary comprises formatted text including predetermined tags that indicate the travel information, and wherein parsing the electronic travel itinerary to extract the travel information comprises recognizing the predetermined tags and extracting the travel information.

11. The method of claim 10 wherein the formatted text comprises a markup language.

12. The method of claim 1 further comprising:
receiving the travel itinerary in an email;
determining whether the email is associated with a registered subscriber; and
parsing the email contents to extract the travel information if the email is associated with a registered subscriber.

13. A computing device comprising:
a first interface configured to communicate data with one or more subscribers; and
a controller configured to:
maintain travel information for a subscriber and for one or more friends in the subscriber's social network;
determine whether the subscriber will be geographically near a friend for at least a predetermined length of time by comparing the travel information associated with the subscriber with the travel information associated with the friend; and
send a notification message to the subscriber based on the determination via the first interface.

14. The device of claim 13 wherein the controller is further configured to:
calculate a length of time that the subscriber will be at a first location while the friend will be at a second location; and
if the length of time equals or exceeds a subscriber-specified time value, calculating a distance between the first and second locations.

15. The device of claim 14 wherein the controller is further configured to select one of a plurality of formulae to calculate the length of time that the subscriber will be at the first location while the friend will be at the second location.

16. The device of claim 14 wherein the controller is further configured to generate the notification message for the subscriber if the length of time equals or exceeds the subscriber-specified time value, and if the calculated distance does not exceed a subscriber-specified distance value.

17. The device of claim 16 wherein the controller is further configured to send another notification message to the friend if the length of time equals or exceeds a friend-specified time value, and if the calculated distance does not exceed a friend-specified distance value.

18. The device of claim 13 wherein the controller is further configured to:
receive subsequently provided travel information associated with at least one of the subscriber and the friend;
determine whether the subscriber will be geographically near the friend for at least a predetermined length of time based on subsequently provided travel information; and
notify at least one of the subscriber and the friend if the subscriber will no longer be within a predetermined distance of the friend for at least a predetermined length of time.

19. The device of claim 13 wherein the controller is further configured to:
receive an electronic travel itinerary travel itinerary associated with the subscriber, the electronic travel itinerary including the travel information for the subscriber; and
parse the electronic travel itinerary to extract the travel information for the subscriber without manual entry of the travel information by the subscriber.

20. The device of claim 19 wherein the travel itinerary comprises a table having rows and columns, and wherein the controller is further configured to extract the travel information from the rows and columns.

21. The device of claim 19 wherein the electronic travel itinerary comprises formatted text that includes tags indicating the travel information, and wherein the controller is further configured to recognize the tags and extract the associated travel information.

22. The device of claim 13 wherein the controller is further configured to detect a predetermined event, and determine whether the subscriber will be geographically near a friend for at least a predetermined length of time responsive to detecting the predetermined event.

23. A computer readable medium having application logic stored thereon, the application logic comprising instructions configured to control a device to:
maintain travel information for a subscriber and for one or more friends in the subscriber's social network;
determine whether the subscriber will be geographically near a friend for at least a predetermined length of time by comparing the travel information associated with the subscriber with the travel information associated with the friend; and
generate a notification message for the subscriber if the subscriber will be geographically near the friend for time period that is greater than or equal to the predetermined length of time.

24. The computer readable medium of claim 23 wherein the application logic comprises instructions further configured to control a device to:
calculate a length of time that the subscriber will be located at a first location while the friend will be located at a second location; and
calculate a distance between the first and second locations if the calculated length of time is greater than or equal to the predetermined length of time.

25. The computer readable medium of claim 24 wherein the application logic comprises instructions further configured to control a device to generate another notification message for the friend if the calculated length of time exceeds is greater than or equal to the predetermined length of time, and if the calculated distance is less than a predetermined distance value.

26. The computer readable medium of claim 23 wherein the application logic comprises instructions further configured to control a device to:
determine whether the subscriber will be geographically near the friend for at least a predetermined length of time based on subsequently provided travel information associated with at least one of the subscriber and the friend; and
notify at least one of the subscriber and the friend if the subsequently provided subscriber travel information indicates that the subscriber will no longer be within a predetermined distance of the friend for at least a predetermined length of time.

27. The computer readable medium of claim 23 wherein the application logic comprises instructions further configured to control a device to:
receive an electronic travel itinerary associated with the subscriber, the electronic travel itinerary including the travel information for the subscriber; and
parse the electronic travel itinerary to extract the travel information for the subscriber without manual entry of the travel information by the subscriber.

28. The computer readable medium of claim 27 wherein the electronic travel itinerary comprises a table having rows and columns, and wherein the application logic comprises instructions further configured to control a device to extract the travel information from the rows and columns.

29. The computer readable medium of claim 27 wherein the electronic travel itinerary comprises formatted text having predefined tags that indicate the travel information, and wherein the application logic comprises instructions further configured to recognize the predefined tags and extract the associated travel information.

30. The computer readable medium of claim 23 wherein the application logic defines a first interface to communicate notification data with a subscriber.

31. The computer readable medium of claim 23 wherein the application logic defines a second interface to communicate travel data with one or more third party servers via a communication network.

32. The computer readable medium of claim 23 wherein the application logic defines a third interface to receive input from the subscriber.
